(19) United States
(12) Patent Application Publication
(10) Pub. No.: US 2026/0268296 A1
(43) Pub. Date: Sep. 10, 2026

(54) SYSTEMS AND METHODS FOR USE IN AUTOMATED INFERENCE DETERMINATION, IN CONNECTION WITH HOST IDENTIFICATION

(71) Applicant: MASTERCARD INTERNATIONAL INCORPORATED, PURCHASE, NY (US)

(72) Inventors: Christian PANTON, Albertslund (DK); Isak NUUR, Ebeltoft (DK); Satyajeet Anand TRIPATHY, Copenhagen (DK); Tomasz WARDZIAK, Zyrardów (PL); Vaidy SUBRAMANIAN, New York, NY (US)

(21) Appl. No.: 19/556,984

(22) Filed: Mar. 4, 2026

Related U.S. Application Data
(60) Provisional application No. 63/767,526, filed on Mar. 5, 2025.

(51) Int. Cl. G06Q 20/10; G06F 16/2455

(52) U.S. Cl. CPC G06Q 20/10; G06F 16/2455

(57) ABSTRACT

Systems and methods are provided for use in automated inference in connection with host identification. One example computer-implemented method includes in response to an input from a user, soliciting an identifier of the user; receiving, via a first interface, by a computing device of a first party, a user input, which includes the identifier of the user; inferring, based on the identifier, at least one account host as associated with the user; and automatically displaying, by the computing device, via a second interface, the inferred at least one account host as a default account host to the user, whereby entry of an intended account host by the user is not required.

### CROSS-REFERENCE TO RELATED APPLICATION

This application claims the benefit of, and priority to, U.S. Provisional Patent Application No. 63/767,526, filed on Mar. 5, 2025. The entire disclosure of the above application is incorporated here by reference.

### FIELD

The present disclosure generally relates to systems and methods for generating automated inferences in connection with host identification.

### BACKGROUND

This section provides background information related to the present disclosure which is not necessarily prior art.

It is known for users to be issued accounts, by account hosts, through which the users are permitted to interact with first parties through the accounts. The accounts may include, for example, payment accounts, which are issued by issuing banks. The accounts are generally identified by primary account numbers, or tokens, etc., depending on the manner in which the accounts are presented to first parties. In connection therewith, the first parties, and other entities associated with transactions funded by the accounts, compile transaction data representative of the same.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in generating automated inferences in connection with host identification;

FIG. 2 is a block diagram of an example computing device that may be used in the system of FIG. 1;

FIG. 3 includes a flow diagram of an example method, which may be implemented in connection with the system of FIG. 1, for use in generating automated inferences in connection with identifying hosts to populate user interfaces; and

FIGS. 4A-4C illustrate example checkout interfaces, which may be used in connection with the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with an interaction between a user and a first party (e.g., at checkout for one or more product purchased by the user from the first party, etc.), the user identifies a type of payment (e.g., credit card, debit card, etc.), and then, also a specific account to fund the interaction (e.g., a transaction for the product(s), etc.). As it relates to identifying the account, the user may identify the account by account number (e.g., where the account is a credit, debit, etc., account) (i.e., in a card scenario), or may select an account host (e.g., an issuing bank, etc.), prior to inputting data specific to the account (e.g., an account number, etc.) (i.e., as in an account-to-account (A2A) interaction (e.g., an open banking transaction, etc.)). As part of the later, the identification of the account host is an additional step in the interaction process, that extends the time and friction involved in interaction and provides inefficiencies in the manner in which data is communicated. It is a technical problem that the account host is not identified automatically based on associated data.

Uniquely, the systems and methods herein provide for making, generating, determining, etc. automated inferences in connection with host identification, whereby the account host is presented to the user in connection with a first party interaction.

In particular, in response to an input from a user, a computing device solicits an identifier of the user, and thereafter, receives, via a first interface, by a computing device of a first party, a user input, which includes the identifier of the user. The computing device then infers, based on the identifier, at least one account host as associated with the user, and then automatically displaying, by the computing device, via a second interface, the inferred at least one account host as a default account host to the user, whereby entry of an intended account host by the user is not required. In this manner, the computing device provide a technical solution to the above technical problem through the unique inference analysis, based on the user identifier.

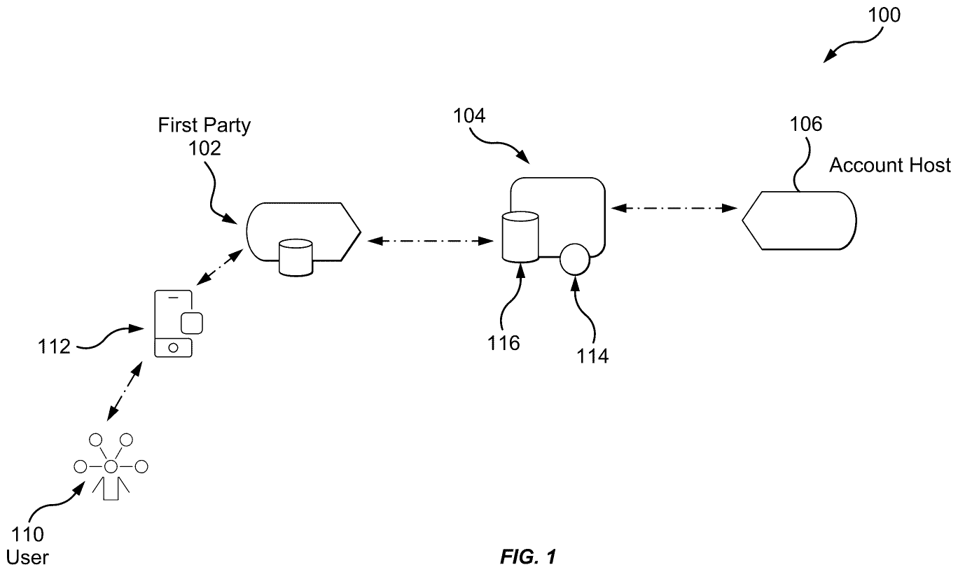

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships, types of users, institutions, customers, open service types, privacy regulations and/or requirements, etc.

The system 100 generally includes a first party 102 (e.g., a merchant in the illustrated embodiment, etc.), a processing network 104, and an account host 106, each of which is coupled to (and is in communication with) one or more networks. The network(s) is/are indicated generally by arrowed lines in FIG. 1, and may each include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. One or more of the networks may further be segregated or separated, whereby, for example, the segregated or separated network(s) may include a private payment transaction network provided by the processing network 104 to the account host 106, and separately, a public network (e.g., the Internet, etc.) through which the first party 102 and a user 110 (i.e., via a communication device 112 associated therewith) communicate, or through which the first party 102 communicates with the processing network 104, etc. with regard to processing a transaction, etc.

In this example embodiment, the first party 102 is associated with one or more products, which are offered for sale to various users, including the user 110, for example.

The first party 102 may be available to (and/or accessed by) the user 110 at a virtual location, which may include, for example, a website (i.e., hosted by or on behalf of the first party 102), application, etc. The virtual location, consequently, is accessible by the user 110, at the communication device 112, via a browser at the communication device 112. The browser may include, for example, Microsoft Edge, Google Chrome, Apple Safari, etc. When the virtual location is accessed, the user 110 is permitted to browse the one or more products offered by the first party 102, select one or more of the products for purchase, add the one or more products to a virtual shopping cart, and then proceed to checkout to purchase the product(s), via the virtual location, as described in more detail below.

In this example embodiment, the account host 106 is a bank or other financial institution, which is configured to issue one or more accounts to the user 110. The account(s), in this example, includes at least one bank account, such as, for example, a checking account, etc., and may further include one or more credit accounts, prepaid accounts, etc. The account host 106 may also be referred to herein as an issuer or issuer institution. The account of the user 110 is the source of the funds to be paid to the first party 102, for example, via transactions performed by the user 110 at the first party 102 to purchase one or more products. In this example embodiment, the account host 106 is configured to expose one or more open banking APIs and/or to initiate and respond to communications consistent with one or more open banking protocols/APIs, etc.

The processing network 104 is coupled in communication between the account host 106 and the first party 102. The processing network 104 is configured to provide communication for purposes of authorization, clearing and settlement of interactions initiated by the first party 102, etc. (broadly, for processing transactions). The transactions (as well as other transactions in the system 100) are each facilitated through an authorization request, generated by the first party 102 and communicated through the processing network 104 to the account host 106, and through an authorization reply generated by the account host 106 and communicated back to the first party 102, via the processing network 104, as described below.

The processing network 104 is configured, in connection with the above, to compile and store transaction data for interactions coordinated therethrough in a database 116. The transaction data may include, without limitation, account numbers (or tokens), user identifiers, first party identifiers, category codes (e.g., merchant category codes (MCCs), etc.), location data, time/date data, amounts, and other suitable data representative of the interaction and/or parties thereto, etc.

In addition, the processing network 104 is configured to offer value added services, such as, for example, click-to-pay, card-on-file, etc., services to the first party 102. In connection therewith, the database 116 of the processing network 104 further includes account numbers, which are issued to and enrolled by users (e.g., including the user 110, etc.) with the first party 102 for use in transactions at the first party 102. The database 116 includes, for each account, an account number or partial account number (e.g., last four digits, BIN, etc.) (and/or account token representative of the account number), brand data for the account, card artwork for the account (e.g., directly or via URL, etc.), etc.

In this example embodiment, the system 100 further includes an inference host 114, which is a computing device configured to receive an identifier from the first party 102, to infer one or more account hosts for one or more users, and to return the inference to the first party 102, whereby the inference may be a basis for populating one or more inputs to the one or more users.

In particular, referring again to checkout at the first party 102, the user 110 indicates a desire to check out and fund a transaction for the products included in a shopping cart in the virtual location of the first party 102.

In response, the first party 102 is configured to solicit an identifier unique to the user 110, such as, for example, a phone number, email address, etc., and also a method of payment from the user 110. The user 110, in turn, inputs the identifier (e.g., through a text input to the virtual location (e.g., via an input device, etc.), etc.) and selects, in this example, to procced with an account-to-account (A2A) transfer to fund the transaction. The first party 102 is configured to receive the identifier (and the selected method of payment) and to transmit the identifier to the inference host 114.

The inference host 114 is configured to then look up and infer one or more account hosts for the user 110, as potentially to be used in the A2A transfer, based on the user's identifier.

Specifically, in one example, the inference host 114 is configured to search in the database 116 for the identifier associated with one or more accounts and return whatever data (in the database 116) is related to the account, and any associated value added services (e.g., click-to-pay, card-on-file, etc.). This data may include the card art or a part of an account number, such as, for example, a bank identification number (BIN), etc. The BIN may be used, for example, as non-sensitive information. The inference host 114 is configured, then, to infer the account host (e.g., the account host 106, etc.) for the user's account, based thereon. That is, the inference host 114 is configured to read the account host from the card art, or look up the account host based on the BIN.

Additionally, or alternatively, in inferring the one or more account hosts, the inference host 114 is configured to search for the identifier in transaction data, which is included in the database 116 and representative of a plurality of transactions processed through the processing network 104. When a transaction is identified based on the identifier, the inference host 114 is configured to then capture an account number of the account to which, or from which, funds are directed, separate the BIN from the account number as non-sensitive information, and to look up the account host specific to the account.

The inference host 114 may be configured to search for numerous instances of the identifier used in the transaction, which may serve to identify one or more account hosts.

Based on the lookup, the identified account host is then inferred, by the inference host 114, to be an account host linked to the user 110 through the transaction data. The inference may be based on a threshold number of transactions being associated with the identifier. For example, where at least five (or more or less) transactions include an account number tied to one account host, and are also associated with an email address, a relationship between the user 110 and the account host is inferred.

Other non-sensitive information, such as, for example, account type, product, brand, segment, etc., may be employed by the inference host 114 to infer that the user 110 may select the specific account host.

Next, the inference host 114 is configured to return the inferred account host(s) to the first party 102.

In connection with the checkout, the user 110 may request, or select, an account to account transfer to fund the transaction (e.g., via open banking, etc.). In response, the first party 102 is configured to display a checkout interface at the virtual location of the first party 102 to the user 110, which includes the option to input an account host (i.e., which issued the account from which the user 110 desires to transfer the funds). In connection therewith, uniquely, the first party 102 is configured to set or preselect the inferred account host(s) as the default account host for the transaction (e.g., account host 106, etc.), and then to include the default setting in the interface displayed to the user 110. In this way, the inferred account host(s) is(are) preselected or otherwise presented as the account host of the user 110, based on the designation of the account host(s) from the inference host 114. The user 110 then has the option to select to proceed with the default account host, i.e., the inferred account host, as preselected, or to select to change to a different account host. When the default account host is the account host desired by the user 110, the user 110 simply proceeds without being required to manually select, enter, or identify the account host 106, and, in the same or a next interface at the virtual location of the first party 102, enters account details (e.g., account number, routing number, etc.).

The first party 102 is configured to proceed to initiate the account to account transaction, through the account host 106. In this embodiment, the transaction is initiated through open banking APIs between the account of the first party 102 and the account of the user 110 at the account host 106. When the transaction is approved and/or complete, the first party 102 is configured to confirm the transaction, via a further interface at the virtual location of the first party 102, to the user 110.

While the above embodiment is specific to checkout, it should be appreciated that the inference host 114 may be configured to infer specific account hosts in connection with adding open banking accounts to existing wallet solutions, validating a bank account for disbursements or payouts, transferring card subscriptions to direct debit and/or ACH mandates, etc.

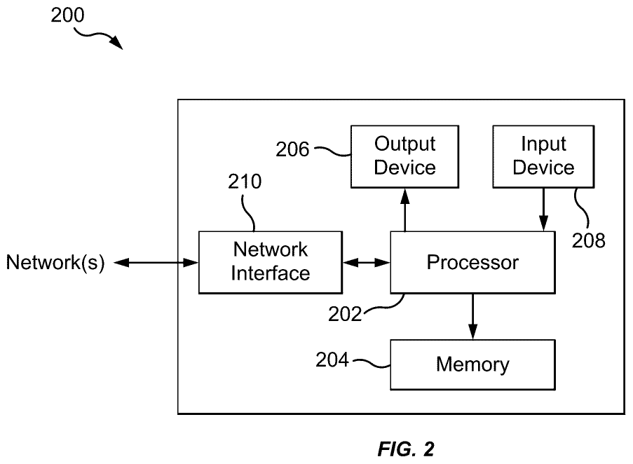

FIG. 2 illustrates an example computing device 200 that may be used in the system 100. The computing device 200 may include, for example, one or more servers, workstations, personal computers, laptops, tablets, smartphones, PDAs, terminals, virtual machines, etc. In addition, the computing device 200 may include a single computing device, or it may include multiple computing devices located in close proximity or distributed over a geographic region, so long as the computing devices are specifically configured to function as described herein. In the system 100 of FIG. 1, each of the first party 102, the processing network 104, the account host 106, the interference host 114, and the communication device 112 may include or may be implemented in a computing device (or multiple computing devices) consistent with computing device 200 coupled to (and in communication with) one or more networks. That said, the system 100, or parts thereof, should not be understood to be limited to the computing device 200, as other computing devices may be employed in other system embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, identifier, BINs, card art, and/or other types of data (and/or data structures) as needed and/or suitable for use as described herein.

Furthermore, in various embodiments, computer-executable instructions are stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special purpose computing device. It should be appreciated that the memory 204 may include a variety of different memories, each implemented in one or more of the operations or processes described herein.

In the example embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., bank names, etc.), either visually or audibly, to a user of the computing device 200, for example, the user 110 in the system 100, etc. In connection therewith, various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user inputs) such as, for example, selection of payment type, etc. by user 110, or inputs from other computing devices. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network(s) of the system 100. Further, in some example embodiments, the computing device 200 may include the processor 202 and one or more network interfaces incorporated into or with the processor 202.

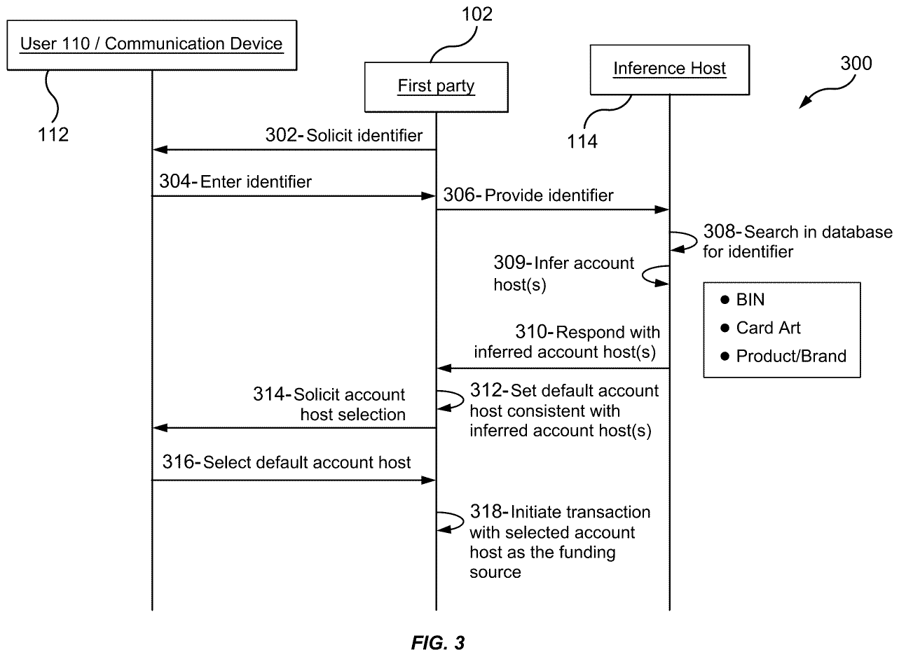

FIG. 3 illustrates an example method 300 for use in making automated inferences in connection with account host identification. The example method 300 is described as implemented in the system 100 and reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

It should be further understood that the inclusion/description of an interaction checkout scenario in the method 300 is for purposes of illustration only. The method 300 may be employed in other situations in which an account host is to be selected by the user 110, including, in connection with adding open banking accounts to a wallet, validating an account for disbursements, payouts, etc., transferring card subscriptions to direct debit and/or ACH mandates, etc. As such, the method 300 is not limited to checkout sequences.

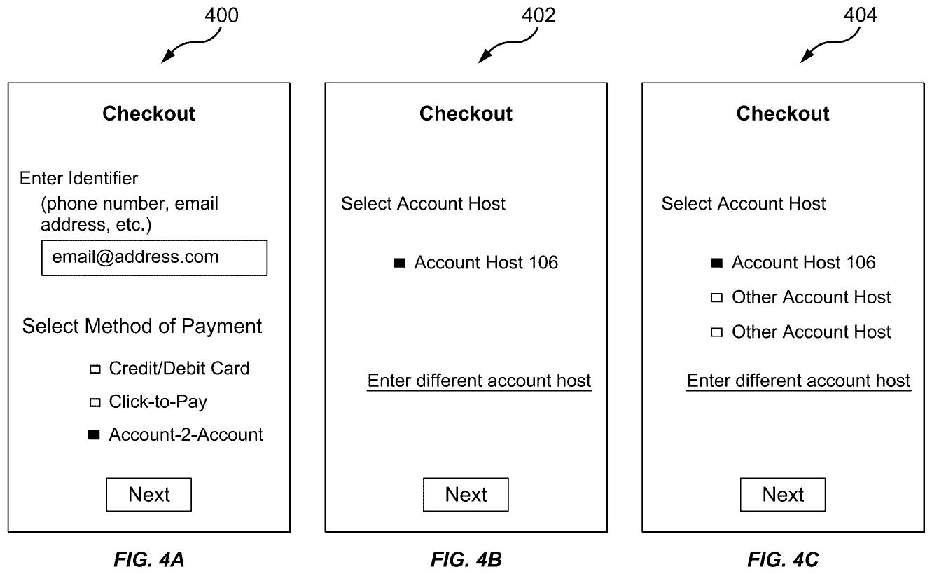

With reference to FIG. 3, at the outset, the user 110 browses through various products at the first party 102, via the virtual location, and selects one or more products, adds the one or mor products to shopping cart, and then selects to checkout to proceed to purchase the one or more products. The first party 102 displays a checkout interface at the communication device 112, in which the first party solicits, at 302, an identifier from the user 110 and also a selection of a method of payment. An example interface 400, which is displayed to the user 110 at the communication device 112, is illustrated in FIG. 4A. The checkout interface 400 solicits an identifier for the user 110, such as, for example, an email address, phone number, etc. In addition, the checkout interface 400 offers various types of payment methods, including, for example, account-to-account (A2A), click-to-pay, card-on-file, credit/debit card, etc. The user 110 enters, at 304, at the communication device 112, an identifier specific to the user 110 into the interface 400 at the virtual location of the first party 102. The identifier may include, without limitation, an email address, a phone number, a government-issued number, a unique sequence/code, or other suitable identifier, etc.

It should be appreciated that the user 110 further selects and/or enters a method of payment, such as, for example, the A2A payment method, via the virtual location at the communication device 112.

At 306, the first party 102 provides the identifier to the inference host 114 (e.g., through an API call, etc.).

At 308, the interface host 114 searches in one or more databases for the identifier and automatically infers, at 309, one or more account hosts is associated with the identifier.

In one example, the inference host 114 automatically searches in the database 116, which includes enrolled accounts for users to one or more value added service. The identifier, as part of the search, may be matched to a database entry, which includes a partial account number, card art for the account (e.g., by URL or content, etc.), a product or brand of the account, etc. When the database entry includes a partial account number, such as, for example, a BIN, the inference host 114 uses the BIN to look up the account host associated with the BIN (e.g., in the database 116, etc.). When the database entry includes card art, the inference host 114 may read the account host from the URL of the card art, or recognize the account host from the card art (e.g., read the brand or account name from the image, etc.). When the database entry includes the product or brand name, the inference host 114 looks up the product/brand to identify the account host (e.g., in the database 116, etc.).

It should be appreciated that other content specific to the account, as stored in the database 116 in connection with one or more value added services, may be used to infer the account host.

In another example, the inference host 114 automatically searches in the database 116 for the identifier. In particular, the database 116 includes separate entries for a plurality of separate prior transactions. For example, an authorization request may include an email address, or phone number, etc., which is stored in the database 116, along with an account number for the funding account, etc. The inference host 114 searches the database entries for the identifier, and locates one or more database entries which include the identifier. The inference host 114 then pulls the account number for each of the database entries with the identifier. The account numbers include BINs, which the inference host 114 uses to look up the BINs to identify the account hosts. The inference host 114 may tally or count the number of occurrences of the account hosts for the specific identifier. Where there is only one account host identified in this manner, the inference host 114 infers the account host is associated with the identifier. Where there are multiple account hosts, the inference host 114 infers each are associated with the identifier in order, from most occurring account host to least occurring account host.

In addition to a number of occurrences, the inference host 114 may rely on other non-sensitive information to infer the account host 106. For example, where the account number included in the transaction data is a debit account, the inference host 114 may apply a greater probability of use of an account for the account host based on the specific type of account. A debit account, for example, may indicate a stronger connection with the account host than a credit account or a prepaid account, because the debit account is a specific type of account at the account host (e.g., checking or saving account, etc.) more likely to be eligible for A2A transfers. Customer segments of the specific account (e.g., gold, platinum, silver, preferred, etc.), as indicated by the product, brand or BIN, may also inform the inference about which account host would be used by the user 110 in the A2A transfer. For example, a business segment account is likely to indicate that the user 110 is required to interact with the business channel of the account host 106, further limiting manual selection at later interfaces.

At 310, the inference host 114 responds to the first party 102 with the one or more inferred account hosts, and sets one or more of the inferred account hosts as a default (or pre-selected) account host. in one example, the default account may be merely listed, or listed first based on the inference.

The first party 102 then displays a subsequent checkout interface, in which the inferred account host (or a selected one of multiple identified account hosts) is designated as a default or preselected. As such, the default account host is preselected, whereby for one inferred account host, the user 110 is permitted to advance to a next checkout interface without selecting the account host. FIG. 4B illustrates an example checkout interface 402 that is displayed to the user 110 at the communication device 112, in which the account host 106, as inferred from the inference host 114, is preselected as the default account host, along with an option to manually enter a different account host. In this way, the user 110 only has to select “Next” to proceed, whereby there is no requirement to manually enter or select a specific account host to the exclusion of other account hosts.

Or, in examples that include multiple inferred account hosts, the most prominent account host may be preselected as the default account host. FIG. 4C illustrates an example checkout interface 404 that is displayed to the user 110 at the communication device 112, in which multiple account hosts are listed for review by the user 110 with one of the account hosts preselected as the default account host. In this example, the inference host 114 inferred three different account hosts may be associated with the user 110, and potentially selectable by the user 110. The account hosts are included in the checkout interface 404 in order, as defined by the inference host 114 with the account host 106, for example, being first and preselected. The order, again, may be based on frequency or count of occurrences of the account host, probability, etc.

Referring again to the method 300, through the checkout interface, the first party 102 solicits, at 314, the user to select an account host.

At 316, the user 110 selects the account host, by advancing in the checkout (e.g., the next button in the interface of FIGS. 4B-4C, etc.). In this way the account host is identified to the first party 102, whereby, at 318, the first party 102 proceeds with the checkout via the A2A payment, with the account host 106 as the funding bank. This may include initiating the A2A transfer, via one or more open banking API calls and/or responses.

In view of the above, the systems and methods herein provide for making automated inferences in connection with host identification, whereby available non-sensitive data related to users is leveraged to infer account hosts associated with the users. In doing so, the inferred account hosts are presented to the users in sequence, including the identification of the account hosts, to limit the user input in connection with the interactions and effectively reduce the friction of the users at the first parties in connection therewith. In this way, the sequence of steps associated with the first parties is more efficient.

As such, pursuant to the inferences of the account hosts, the first parties automatically display the account hosts to the users based on an apparent association of the account hosts with the users, which provides a specific improvement over prior sequences and which results in an improved user interface for the specific first party computing devices. What's more, in this way, automatically determining one or more inferences related to the account host and the user, based on a prior relation, and automatically displaying in relative order, based on the user-specific inference, provides specific improvement over prior systems (in which order is random, or alphabetic or based on relations between the first party and the account host, etc., i.e., generally irrelevant to the specific user), resulting in an improved user interface for electronic devices.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) in response to an input from a user, soliciting an identifier of the user; (b) receiving, via a first interface, by a computing device of a first party, a user input, which includes the identifier of the user; (c) inferring, based on the identifier, at least one account host as associated with the user; and/or (d) automatically displaying, by the computing device, via a second interface, the inferred at least one account host as a default account host to the user, whereby entry of an intended account host by the user is not required.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in generating automated inferences in connection with host identification, the method comprising:
in response to an input from a user, soliciting an identifier of the user;
receiving, via a first interface, by a computing device of a first party, a user input, which includes the identifier of the user;
inferring, based on the identifier, at least one account host as associated with the user; and
automatically displaying, by the computing device, via a second interface, the inferred at least one account host as a default account host to the user, whereby entry of an intended account host by the user is not required.

2. The computer-implemented method of claim 1, wherein the identifier includes one of an email address and a phone number.

3. The computer-implemented method of claim 1, wherein inferring the at least one account host includes:
searching, by an inference host computing device, for the identifier in a database; and
based on the identifier being included in an entry in the database, inferring the at least one account host based on information included in the entry.

4. The computer-implemented method of claim 3, wherein the information includes card art for an account of the user, which is issued by the at least one account host.

5. The computer-implemented method of claim 3, wherein the information includes a bank account identifier (BIN) of the at least one account host.

6. The computer-implemented method of claim 5, further comprising, in response to the identifier being included in multiple entries of the database, counting a number of occurrences of a first account host and a second account host;
wherein the at least one account host includes the first account host and the second account host; and
wherein inferring the at least one account host includes inferring the first account host and the second account host, in order based on the number of occurrences of each of the first account host and the second account host.

7. The computer-implemented method of claim 1, wherein the second interface further includes an option for manual entry of an account host other than the default account host.

8. The computer-implemented method of claim 1, further comprising:
selecting, by the computing device, via a third interface, an account number for the account of the user at the at least one account host; and
initiating, by the computing device, a fund transfer between the account at the at least one account host and an account associated with the first party based on the at least one account host being selected by the user as the default account host.

9. A non-transitory computer-readable storage medium comprising executable instructions for use in generating an automated inference in connection with host identification, which when executed by at least one processor, cause the at least one processor to:
in response to an input from a user, solicit an identifier of the user;
receive, via a first interface through a first party, a user input, which includes the identifier of the user;
infer, based on the identifier, at least one account host as associated with the user; and
automatically cause displaying, via a second interface, through the first party, the inferred at least one account host as a default account host to the user, whereby entry of an intended account host by the user at the first party is not required.

10. The non-transitory computer-readable storage medium of claim 9, wherein the identifier includes one of an email address and a phone number.

11. The non-transitory computer-readable storage medium of claim 9, wherein the executable instructions, when executed by at least one processor, cause the at least one processor, in inferring the at least one account host, to:
search for the identifier in a database; and
based on the identifier being included in an entry in the database, infer the at least one account host based on information included in the entry.

12. The non-transitory computer-readable storage medium of claim 11, wherein the information includes card art for an account of the user, which is issued by the at least one account host.

13. The non-transitory computer-readable storage medium of claim 11, wherein the information includes a bank account identifier (BIN) of the at least one account host.

14. The non-transitory computer-readable storage medium of claim 13, wherein the executable instructions, when executed by at least one processor, further cause the at least one processor to, in response to the identifier being included in multiple entries of the database, count a number of occurrences of a first account host and a second account host;
wherein the at least one account host includes the first account host and the second account host; and
wherein the executable instructions, when executed by at least one processor, cause the at least one processor, in inferring the at least one account host, to infer the first account host and the second account host, in order based on the number of occurrences of each of the first account host and the second account host.

15. The non-transitory computer-readable storage medium of claim 11, wherein the second interface further includes an option for manual entry of an account host other than the default account host.

16. The non-transitory computer-readable storage medium of claim 11, wherein the executable instructions, when executed by at least one processor, further cause the at least one processor to:
select, via a third interface, an account number for the account of the user at the at least one account host; and
initiate a fund transfer between the account at the at least one account host and an account associated with the first party based on the at least one account host being selected by the user as the default account host.

17. A system for use in generating automated inferences in connection with host identification, the system comprising:
a processing network including computing device, which includes a processor, configured by executable instructions, to:
receive, from a first party computing device, an identifier of a user;
infer, based on the identifier, from transaction data representative of a plurality of transactions processed through the processing network, at least one account host as being associated with the user; and
identify, to the first party, the inferred at least one account host as a default account host to the user, whereby the first party automatically identifies the at least one account host as a default in an interface displayed to the user.

18. The system of claim 17, wherein the processor is configured, by the executable instructions, to infer the at least one account host based on a count of ones of the plurality of transaction, which include the identifier and the at least one account host.
